(19) United States
(12) Patent Application Publication
(10) Pub. No.: US 2005/0170706 A1
(43) Pub. Date: Aug. 4, 2005

(54) Lamp holder for wireless lamps with quick socket and relative lamp

(75) Inventor: Lino Zonta, S. Stino Di Livenza (IT)

Correspondence Address: John S. Egbert;Harrison & Egbert, 7th Floor, 412 Main Street, Houston, TX, 77002, US

(73) Assignee: ISO ITALIA S.p.a., S. Stino di Livenza (IT)

(21) Appl. No.: 11/045,599

(22) Filed: Jan. 28, 2005

(30) Foreign Application Priority Data
Jan. 30, 2004 (IT) PD2004A000030

(51) Int. Cl. H01R 4/24

(52) U.S. Cl. 439/857

(57) ABSTRACT

The lamp holder for linear lamps, with body in insulating material and a contact element, includes an element shaped in a way to have a seat, for the contact of the lamp. The seat has a cylindrical central portion around which there are two opposite arched walls flexible-enlargeable with two upper divergent flanges. The lamp has end contacts between the flanges of the contacts of the lamp holder in order to receive the cylindrical parts of the seats of the contact elements inside the end contacts of the lamp. By the rotation of the lamp around the cylindrical parts of the contact elements in the lamp holder the direct removing of the lamp from the lamp holder is avoided.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This patent relates to wireless lamps with an electric contact at each end and to relative lamps.

### BACKGROUND OF THE INVENTION

Wireless lamps with an electric contact at each end are known.

Halogen wireless lamps are widely used due both to their high brilliancy and to their small dimensions.

Halogen lamps with a contact at each end, from now on briefly referred to as lamps, have each end electric contact made of a hollow metallic seat connected to the internal filament.

Lamp holders for said lamps, used coupled and opposite, are made of a support, realized in insulating material typically ceramic, having a foil provided at one end with a semi-spherical relief fit for being positioned into the hollow seat of the contact of the lamp.

Each foil is then connected with one of the electric feed poles.

The insertion of said lamps between two lamp holders is simply performed by positioning a contact of the lamp on the contact of a lamp holder, pushing in a way to flex the foil enough so as to exactly realize the opposite contact of the lamp on the other lamp holder.

The lamp is held simply by the pressure of the two foils of the two lamp holders, and by the corresponding semi-spherical relieves, at the ends and on the hollow contacts of the lamp itself.

The lamps and relative lamp holders thus realized are simply to realize and more then this the application of the lamps on the lamp holders is quick and simple.

Anyway said lamps and relative lamp holders have some drawbacks.

The lamps, in particular the halogen lamps, produce a big amount of heat that is transmitted also to the lamp holder and to the foils of the contacts.

Both due to the heat and to the various substitutions of the lamps, the foils loose their elastic ability to flexion, thus enlarging and holding the lamp only partially.

If the lamp is not inserted in a correct way into the lamp holder, because of the heat of the lamp itself or because of some movements, the hollow end contact of the lamp and the relieved contact of the foil of the lamp holder can be not properly aligned thus causing following overheating and oxidation of the contacts and an electric arc between the two contacts.

If the foils can't hold the lamps with enough energy, possible crashes, bumps or alike can cause the release of the lamp with the possibility of an explosion, burns or others.

### BRIEF SUMMARY OF THE INVENTION

In order to overcome to the above cited drawbacks a new lamp holder for lamps and relative lamp with safety contacts has been studied and carried out.

It is a new linear lamp and lamp holder.

The application is specific for any kind of linear lamps in the field of the sun tanning and also for civil and industrial uses in the field of lightning.

Aim of the new lamp holder is to prevent the undesired release, fall, or detach of the lamp.

Another aim of the new lamp holder and the relative lamp is to assure a continuous and optimum contact between the electric contacts of the lamp holder itself and the electric contacts of the lamp.

Another aim of the new lamp holder and of the relative lamp is to facilitate and allow a quicker insertion of the lamp in the lamp holder.

Another aim is not to allow the use of lamps with different sockets or contacts on the new lamp holder and also not to allow the use of the new lamp with the new socket on the known lamp holders.

These and other direct and complementary aims are achieved by the new lamp and lamp holder for lamps mainly comprising a support made of a body in an electrically-insulating material and a contact element in a conducting elastic material.

The body is realized in specific insulating material resistant to heat. Said body have many spaces or chambers, one of which fit for receiving the contact element, at least one fit for receiving a fixing element of the lamp holder, at least one hole or space or chamber for the passing or the fixing of the conductor cable.

The contact element is preferably made of an element, in metallic material for electric contacts, shaped and bent in a way to have a seat, for the contact of the lamp, with cylindrical shape and circular or circle-arc shaped section flanked by two diametrically opposed arched walls with edge radially divergent with respect to the cylindrical central part.

The lamp has the end contacts made of an electrically-conducting material, it is substantially shaped as a cylinder, with semi-circular section, coaxial with the lamp itself and having so an opening parallel to its axis.

The lamp is inserted in the lamp holder in a way that the lateral opening of its cylindrical contacts is directed towards the cylindrical part of the contacts of two opposite lamp holders, and in a way that said contacts of the lamp wrap said cylindrical contacts of the lamp holders, passing through the external arched walls of the lamp holders themselves.

The rotation of half turn of the lamp around the axis passing on the contacts directs its contacts towards the inside of the lamp holder, securing the lamp to the lamp holder also in case of crashes, vibrations or similar stresses while in case of breaking of the lamp the contacts remain attached to the lamp holder.

The electric contact between the lamp and each lamp holder is assured both by the central cylindrical part and by the two opposite arched walls of the lamp holder.

### BRIEF DESCRIPTION OF THE SEVERAL VIEWS OF THE DRAWINGS

The characteristics of the new lamp holder for lamps and relative lamp with safety contacts will be clarified by the following description, referring to the figures attached as a non-limitative example.

In FIG. 1 and in FIG. 2 a front view and a sectional view of the new lamp holder (P), mainly comprising a body (S) and a contact element (C), are represented.

FIG. 3

FIG. 4

FIG. 5

### DETAILED DESCRIPTION OF THE INVENTION

The body (S) is made of an electrically insulating material resistant to heat, having many spaces or chambers (S1, S2, S3). At least one of said spaces or chambers (S1) is fit for receiving the contact element (C).

Other spaces or chambers (S2, S3) are fit for receiving, respectively, a fixing element (F1) of the lamp holder (P) to the lamp body or other, and the conductor cable (E) to the contact element (C).

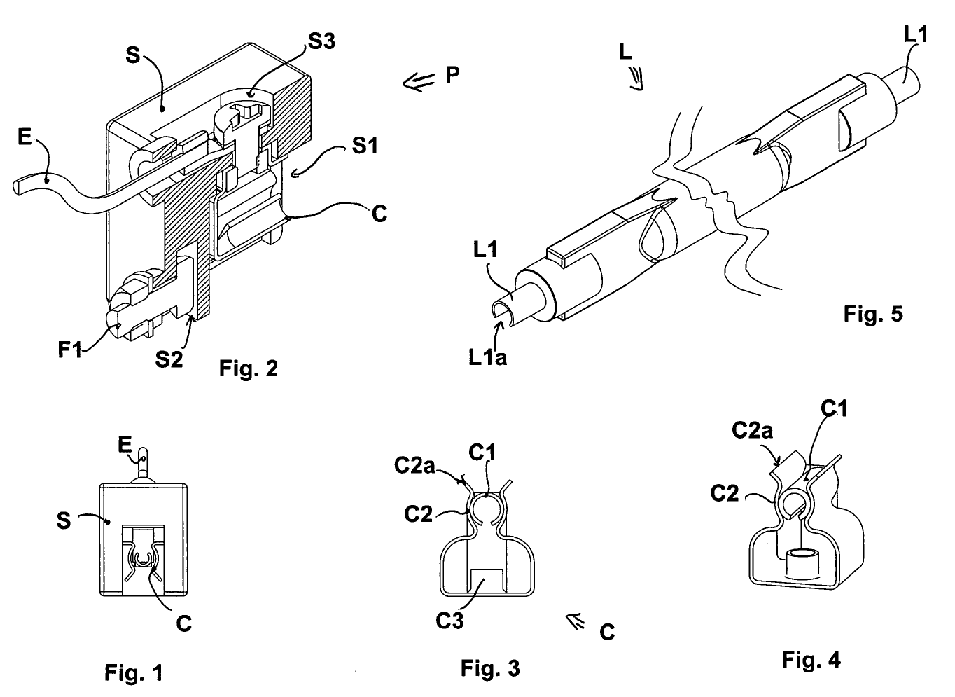

The contact element (C), represented in front view and in axonometric view in FIGS. 3 and 4 is made of a metallic material for electric contacts and it is shaped and bent in a way to have a seat for the contact (L1) of the lamp (L).

Said seat comprises a generically cylindrical central portion (C1) around which there are two opposite arched walls (C2).

The central part (C1) has a section shaped as a circle or as a circle-arc, while the two arched walls (C2) are positioned laterally and diametrically opposite to said central part (C1).

In particular said two arched walls (C2) are partially flexible, or enlargeable, in order to allow the passing of the contact (L1) of the lamp (L) and they have two upper divergent flanges (C2a) in order to facilitate and drive the insertion of the contact (L1) of the lamp (L).

Other parts and/or complementary portions (C3) of the contact element (C), properly shaped, allow the fixing of the contact element (C) itself to the parallelepiped shaped body (S) and the connection of the conductor cable (E) with the contact element (C) itself.

In FIG. 5 an axonometric view of the lamp (L) with safety contacts (L1) is shown.

Substantially each end contact (L1) of the lamp (L) is made of an element in electro-conducting material for electric contacts, substantially shaped as a cylinder, with a lateral opening (L1a) parallel to the contact axis (L1).

Said lateral opening (L1a) is wide enough to allow the passing of the central cylindrical part (C1) of the seat of the contact element (C).

The application of the new lamp (L) with safety contacts (L1) between two new opposite lamp holders (P) is realized by inserting the end contacts (L1) of the lamp (L) between the external arched walls (C2) of the two opposite lamp holders (P) in a way that said contact (L1) of the lamp (L) wraps the cylindrical contact (C1) of the lamp holder (P).

The rotation of half turn of the lamp (L) around the axis passing for the contacts (L1) directs its contacts (L1) towards the inside of the lamp holder (P).

In this way the lamp (L) is held by the lamp holder (P) also in case of vibrations or similar stresses.

The electric contact between lamp (L) and lamp holder (P) is assured both by the central cylindrical part (C1) and by the two opposite arched walls (C2) of the lamp holder (P).

With reference to the above description the following claims are put forth.

1. Lamp holder for lamps, comprising:
a body comprised of electrically insulating material resistant to heat, and
a contact element, comprised of metallic material for electric contacts, wherein the body has many spaces or chambers, at least one of which is fit for receiving the contact element, wherein the contact element is comprised of an element properly shaped and bent in a way to have a seat, for the contact of the lamp, and further comprising a cylindrical central portion around having two opposite arched walls therearound.

2. Lamp holder for lamps according to claim 1, wherein the two arched walls has two upper divergent flanges, and wherein said arched walls are partially flexible, or enlargeable.

3. Lamp holder for lamps according to claim 1, further comprising:
other spaces or chambers fit for receiving a fixing element of the lamp holder to the lamp body or other, and the conductor cable to the contact element.

4. Lamp with end contacts, comprising:
end contacts, each contact being comprised of an element in conducting material for electric contacts substantially shaped as a cylinder, with a longitudinal opening parallel to an axis thereof, wherein said longitudinal opening is wide enough to allow the passing of the central cylindrical part of the seat of the contact element of the lamp holder.

5. Lamp with end contacts, according to claim 4, being coupled with a lamp holder, wherein the end contacts are fit for being inserted and held between the flanges of the contacts of the lamp holder and in a way to receive the cylindrical parts of the seats of the contact elements inside the end contacts of the lamp.

6. Lamp with end contacts, according to claim 4, being rotatable around the cylindrical parts of the contact elements in the lamp holder and around said cylindrical part of said contacts of said lamp holder in a way to avoid the direct release of the lamp from the lamp holder.
